(19) United States
(12) Patent Application Publication
(10) Pub. No.: US 2013/0316019 A1
(43) Pub. Date: Nov. 28, 2013

(54) Production Process for a Stabilized Aqueous Solution of Oxidizing Chlorine and a Stabilized Aqueous Solution of Oxidizing Chlorine Produced in this Manner

(71) Applicants: Cerrato Sergio, Chieri (IT); D'angelo Domenico, Torino (IT); Monti Daniele, Quarrata (IT); Tartaro Daniele, Chieri (IT); Venturello Alberto, Torino (IT)

(72) Inventors: Cerrato Sergio, Chieri (IT); D'angelo Domenico, Torino (IT); Monti Daniele, Quarrata (IT); Tartaro Daniele, Chieri (IT); Venturello Alberto, Torino (IT)

(73) Assignee: DUEDI SRL, Prato (IT)

(21) Appl. No.: 13/861,739

(22) Filed: Apr. 12, 2013

(30) Foreign Application Priority Data
Apr. 13, 2012 (IT) TO 2012 A 000327

(51) Int. Cl. A01N 25/22; C25B 1/26

(52) U.S. Cl. CPC A01N 25/22; C25B 1/265
USPC 424/661; 205/556; 514/769

(57) ABSTRACT

A process is described for the preparation of a stabilized aqueous solution of oxidizing chlorine (anolyte). The process comprises electrolysis of an aqueous solution of sodium chloride or potassium chloride in an electrolytic cell having at least one anode compartment and one cathode compartment separated by a semi-permeable membrane to obtain an anolyte solution in the anode compartment and a catholyte solution in the cathode compartment, and the addition to the anolyte solution produced in this way of a stabilizing agent selected from the group consisting of hydrochloric acid (HCl) of 50 to 250 mg/l, sulphuric acid (H₂SO₄) of 50 to 350 mg/l, phosphoric acid (H₃PO₄) of 50 to 500 mg/l, periodic acid (HIO₄) of 100 to 1000 mg/l, sodium chloride (NaCl) from 1 to 30 g/l, or any combination thereof. The stabilized anolyte solution produced with the process according to the invention has an advantage of a reduced pH value and increased redox potential value, preferably greater than 960.

This application claims benefit of Italian Patent Application No. TO 2012 A 000327 filed Apr. 13, 2012, which is incorporated by reference.

The present invention relates to a process for producing a stabilized aqueous solution of oxidizing chlorine. The invention also relates to the stabilized aqueous solution of oxidizing chlorine produced with the process of the invention.

The aqueous solution of oxidizing chlorine produced with the process of the invention is a known solution called “anolyte,” which is conventionally produced at the anode through electrolysis of an aqueous solution saturated with sodium chloride (NaCl) or potassium chloride (KCl) and which possesses sanitizing and disinfecting properties and is used for sanitizing and disinfecting various kinds of surfaces (such as, for example, surfaces of medical devices) and for treating primary and secondary waters.

Anolyte produced by electrolysis of an aqueous solution saturated with sodium chloride (NaCl) or potassium chloride (KCl) contains active chlorine, mainly in the form of hypochlorite ions (ClO⁻) and hypochlorous acid (HClO).

A technical problem linked to the production of anolyte is represented by the fact that, with conventional processes, anolyte is not obtained in a sufficiently stable form to be preserved for a long enough time to allow for its commercialization as a packaged product, for example in a bottle. The active chlorine present in the solution tends to decompose quickly over time, such that the sanitizing and disinfecting effectiveness of the anolyte is rapidly reduced until it becomes insufficient, generally within a time period of about one month.

So far, this has prevented the commercialization of anolyte as a packaged product and has determined the need for hospitals and industrial establishments, which employ anolyte as a sanitizer and disinfectant, to equip themselves with anolyte generators for its production in bulk and for immediate use.

One example goal of the present invention is therefore to provide a process for producing stabilized anolyte. Another example goal of the present invention is to provide stabilized anolyte with sufficiently long shelf life so that it can be commercialized as a packaged product, for example in bottles. These and other goals are achieved through a process for the production of stabilized anolyte comprising the steps of:

(i) subjecting an aqueous solution of sodium chloride or potassium chloride to electrolysis in an electrolytic cell having at least one anode compartment and one cathode compartment, separated by a semipermeable membrane, to obtain an anolyte solution in the anode compartment and a catholyte solution in the cathode compartment; and

(ii) adding to the anolyte solution a stabilizing agent selected from the group consisting of:
hydrochloric acid (HCl) of 50 to 250 mg/l,
sulphuric acid (H₂SO₄) of 50 to 350 mg/l,
phosphoric acid (H₃PO₄) of 50 to 500 mg/l,
periodic acid (HIO₄) of 100 to 1000 mg/l,
sodium chloride (NaCl) from 1 to 30 g/l,

or any combination thereof.

The above mentioned stabilizing agents are added to the anolyte in an unaltered state or, preferably, in the form of an aqueous solution. The process for producing stabilized anolyte according to the present invention can be implemented with any known system for generating anolyte, and therefore provides the advantage of considerable flexibility.

In an example embodiment, the anolyte is produced with a process that includes, before the electrolytic reaction, a step of deionizing or softening incoming water in the electrolytic cell, and a step of filtration of the incoming water in the electrolytic cell with filter preferably from 0.2 micron absolute, all with conventional methods and equipment of which the choice and correct use are within the reach of the average person skilled in the art.

In another example embodiment, the saline solution subjected to electrolysis is an aqueous solution of sodium chloride with a concentration of 5 to 13 g/l. A preferred electrolytic cell includes four chambers. Preferably, the system uses a continuous current of 24 volts with approximately 10 amps absorption.

The stabilizing effect of the hydrochloric acid, sulphuric acid, phosphoric acid and/or periodic acid added to the anolyte as stabilizing agents was experimentally demonstrated by the inventors, using a solution of Anolyte added with NaCl 20 g/l, HCl 0.5%, HIO4 0.5%, pH 5.0, by comparing the initial concentration of free chlorine (t₀) with the concentration of free chlorine after various times (t). The concentration of free chlorine in anolyte was measured by means of UV visible spectroscopy. The results obtained are shown in Table 1.

TABLE 1

| Days (25° C.) | ppm |
|---|---|
| 0 | 507 |
| 30 | 427 |
| 60 | 417 |
| 90 | 405 |
| 120 | 401 |
| 150 | 398 |
| 180 | 395 |
| 210 | 393 |
| 240 | 387 |
| 270 | 382 |
| 300 | 381 |

Similar results are obtainable with other combinations of the above stabilizing agents and are within the scope of the present invention.

The inventors have also observed that the addition of the above mentioned stabilizers advantageously brings about not only a decrease of the decomposition rate of the active chlorine, but also a decrease of the pH value and an increase of the redox potential relative to the anolyte originally produced in the anode compartment of the electrolytic cell, while not causing a significant change in the concentration of active chlorine, which lies approximately in the range of 400-600 ppm.

Table 2 below shows a comparison of the pH and potential redox values of anolyte as originally produced at the anode (“initial anolyte”) and of the anolyte after addition of the stabilizing agents according to the invention (“stabilized anolyte”).

TABLE 2

| | Initial | Stabilized |
|---|---|---|
| | anolyte | anolyte |
| pH | 6-7 | 5, 5-7 |
| redox | 950 | >960 |
| potential | | |

The observed increase of redox potential is particularly advantageous for the use of anolyte as sanitizer and disinfectant, since there is a corresponding bactericide and virucide capacity.

A further embodiment of the invention is an aqueous solution of oxidizing chlorine (anolyte), characterized in that it comprises a stabilizing agent selected from the group consisting of:
hydrochloric acid (HCl) of 50 to 250 mg/l,
sulphuric acid (H₂SO₄) of 50 to 350 mg/l,
phosphoric acid (H₃PO₄) of 50 to 500 mg/l,
periodic acid (HIO₄) of 100 to 1000 mg/l,
sodium chloride (NaCl) from 1 to 30 g/l,

or any combination thereof, and further characterized in that the anolyte has a pH between 4 and 7 and a redox potential greater than or equal to 960.

Because of the increased stability over time, the stabilized anolyte solution of the invention is suitable for being commercialized as packaged product, for example in bottles, because it has a shelf life of at least 12 months in unopened packaging and approximately another 5 months after the packaging is opened. According to the employed stabilizing agents, this product is suitable for use as a sanitizer and/or disinfectant in various applications, for instance in the domestic field, for food, industrial or medical applications (for disinfecting and sanitizing medical devices and for disinfecting intact skin or with continuity solution).

It is further noted that the process of the invention provides a very low cost and can easily be integrated within the usual apparatus for generating anolyte, as well as in the normal automated disinfection systems for the treatment of medical devices.

1. A method of producing a stabilized anolyte, comprising the steps of:
(a) optionally deionizing or softening water to produce deionized or softened water;
(b) optionally filtering deionized or softened water; preferably with an absolute 0.2 micron filter, to produce filtered water;
(c) optionally softening filtered water;
(d) subjecting an aqueous solution of sodium chloride or potassium chloride to electrolysis in an electrolytic cell having at least an anode compartment and a cathode compartment separated by a semipermeable membrane, (e) obtaining an anolyte solution in the anode compartment and a catholyte solution in the cathode compartment, (f) adding to the anolyte solution a stabilizing agent selected from the group consisting of:
hydrochloric acid (HCl) from 50 to 250 mg/l,
sulfuric acid (H2SO4) from 50 to 350 mg/l,
phosphoric acid (H3PO4) from 50 to 500 mg/l,
periodic acid (HIO4) from 100 to 1000 mg/l,
sodium chloride (NaCl) from 1 to 30 mg/l,
and any combination thereof.

2. The method according to claim 1, wherein the aqueous solution which is subjected to electrolysis is a saturated sodium chloride aqueous solution.

3. The method according to claim 1, wherein the aqueous solution which is subjected to electrolysis is a sodium chloride aqueous solution at a concentration of 5 to 13 g/l.

4. (canceled)

5. A stabilized anolyte solution, characterized in that it comprises a stabilizing agent selected from the group consisting of:
hydrochloric acid (HCl) from 50 to 250 mg/l,
sulfuric acid (H2SO4) from 50 to 350 mg/l,
phosphoric acid (H3PO4) from 50 to 500 mg/l,
periodic acid (HIO4) from 100 to 1000 mg/l,
sodium chloride (NaCl) from 1 to 30 mg/l,
and any combination thereof; and
further characterized in that it has a pH in the range of 4 to 7 and a redox potential greater than or equal to 960.

6. The use of a stabilized anolyte solution according to claim 5, as a hygienization and/or disinfection agent.

7. The use according to claim 6, in domestic, dietary, industrial and/or medical applications.

8. A packaged hygienizing and/or disinfecting product, comprising a stabilized anolyte solution according to claim 5.

9. The stabilized anolyte solution according to claim 8, wherein the shelf life of the packaged stabilized anolyte solution is at least 12 months in unopened packaging and 5 months after packaging is opened.
